(19) United States
(12) Patent Application Publication
(10) Pub. No.: US 2020/0233290 A1
(43) Pub. Date: Jul. 23, 2020

(54) WAVELENGTH CONVERSION MODULE, PROJECTOR AND METHOD FOR MIXING LIGHT OF A PROJECTOR

(71) Applicant: Qisda Corporation, Taoyuan City (TW)

(72) Inventors: CHIEN-CHIANG HSU, Taoyuan City (TW); KUO-CHUN LEE, Taoyuan City (TW)

(73) Assignee: Qisda Corporation, Taoyuan City (TW)

(21) Appl. No.: 16/738,091

(22) Filed: Jan. 9, 2020

(30) Foreign Application Priority Data
Jan. 18, 2019 (CN) 201910049602.9

(51) Int. Cl. G03B 21/20; G02B 26/00

(52) U.S. Cl. CPC G03B 21/204; G02B 26/008

(57) ABSTRACT

The present invention provides a wavelength conversion module, a projector and a method for mixing light of a projector. The wavelength converting module includes a wheel and at least one first wavelength converting unit. The wheel has a first-color light generating area that includes at least one first-color light generating region and at least one first-color light correcting region. At least one first wavelength converting unit is disposed on at least one first-color light correcting region respectively so as to convert the wavelength of light. The light is incident on one of the first-color light generating regions during the first period of the first time period where the projector projects light of a first color so that an uncorrected first-color light is generated, and incident on the first-color light correcting region adjacent to the said first-color light generating region during the second period of the first time period following the first period so that a color-correcting light is generated. The uncorrected first-color light is combined with the color-correcting light to generate a first composite light.

### BACKGROUND OF THE INVENTION

### 1. Field of the Invention

The present disclosure relates to a wavelength conversion module, projector and method for mixing light of the projector; in particular, it relates to a wavelength conversion module, projector and method for mixing light of the projector that may modulate a color gamut.

### 2. Description of the Prior Art

The current technology provides a fluorescence color wheel irradiated by laser using digital light processing (DLP). The fluorescence color wheel has a plurality of sections. Fluorescence powder corresponding to required light color is disposed on each of the sections so that light sources are configured to emit light of different colors after being disposed on the different sections. Blue laser is often used as the light source of the aforementioned projector due to its high energy, so that excitation efficiency may be enhanced.

However, blue laser with high excitation efficiency tends to differ from the original blue color defined by each color gamut from the perspective of color performance—it is a color between blue and violet. Therefore, a conventional projector in general must choose between high excitation efficiency and color accuracy, yet it is difficult to make such choice. Therefore, a conventional projector has room for improvement.

### SUMMARY OF THE INVENTION

As such, one of the purposes of the present disclosure is to provide a wavelength conversion module, a projector and a method for mixing light of the projector for the current problem, wherein a wavelength converting substance is disposed on the fluorescence color wheel so that the color gamut generated by the wavelength conversion module may be modulated.

An embodiment of the present disclosure provides a wavelength conversion module, disposed on a transmission path of a light emitted by a projector. The wavelength conversion module includes a wheel and at least one first wavelength converting unit. The wheel includes a first-color light generating area. The first-color light generating area includes at least one first-color light generating region and at least one first-color correcting region. At least one first-color light generating region and at least one first-color light correcting region are alternatively distributed in the first-color light correcting area along the rotation direction of the wheel. Each of the first wavelength converting units are respectively disposed on each of the first-color light correcting region and configured to convert the wavelength of light. The light is incident on one of the first-color light generating region during the first period of the first time period where the projector projects light of a first color so that an uncorrected first-color light is generated, and incident on the first-color light correcting region adjacent to the first-color light generating region during the second period of the first time period following the first period so that a corrected color light is generated. The uncorrected first-color light is combined with the corrected color light to generate a first composite light.

Another embodiment of the present disclosure provides a projector which includes the aforesaid wavelength conversion module and a light source configured to emit light.

Another embodiment of the present disclosure provides a method for mixing light of the projector including: enabling a light to be incident on at least one of the first-color light generating regions during the first period so that an uncorrected first-color light is generated; enabling a light to be incident on at least one of the wavelength converting unit during the second period so that an corrected color light is generated; and combining the uncorrected first-color light with the corrected color light to generate a first composite light.

To further understand the technical features and contents of the present disclosure, please refer to the following description and FIGs of the present disclosure; however, the FIGs provided are merely for reference and description, and are not intended to limit the scope of the present disclosure.

### BRIEF DESCRIPTION OF THE DRAWINGS

FIG. 1 is a diagram of a projector of the first embodiment of the present disclosure.

FIG. 2A to FIG. 2C are diagrams respectively illustrating a wheel, a first wavelength converting unit, and a wavelength conversion module of the first embodiment of the present disclosure.

FIG. 3A and FIG. 3B illustrate variant embodiments of the wavelength conversion module of the first embodiment of the present disclosure.

FIG. 4 illustrates a variant embodiment of the wavelength conversion module of the first embodiment of the present disclosure.

FIG. 5A and FIG. 5B illustrate an active state embodiment of the wavelength conversion module in FIG. 4.

FIG. 6 is a flowchart of a method for mixing light of the projector of the first embodiment of the present disclosure.

FIG. 7 illustrates a variant embodiment of the projector of the first embodiment of the present disclosure.

FIG. 8 illustrates another variant embodiment of the projector of the first embodiment of the present disclosure.

FIG. 9 is a flowchart of the method for mixing the light of the projector in FIG. 8.

FIG. 10 is a diagram of the wavelength conversion module of the second embodiment of the present disclosure.

### DETAILED DESCRIPTION OF THE PREFERRED EMBODIMENT

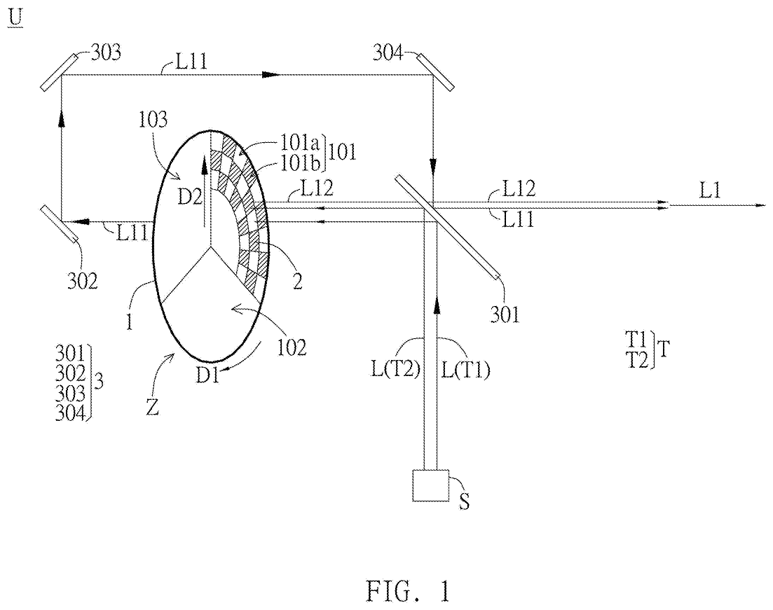

The embodiment of the wavelength conversion module, the projector, and the method for mixing the light of the projector of the present disclosure will be described with reference to FIG. 1 to FIG. 10. People skilled in the art may understand the advantages and the effects of the present disclosure. However, the contents shown in the following sentences never limit the scope of the present disclosure. Without departing from the conception principle of the present disclosure, people skilled in the art may realize the present disclosure through other embodiments based on different views and applications. In addition, it should be firstly stated that, FIGs of the present disclosure are merely used as schematic descriptions, and they do not illustrate based on the actual sizes. In addition, even though the terms such as first, second, third may be used to describe each element, but these elements are not limited by such terms. Such terms are mainly used to differentiate an element from another element.

The first embodiment of the present disclosure is described referring to FIG. 1 to FIG. 9 in the following paragraphs. First please refer to FIG. 1. The first embodiment of the present disclosure provides a projector U, which includes a wavelength conversion module Z, a light source S and a light guide module 3. The wavelength conversion module Z is disposed on a transmission path of a light L emitted by the light source S, and it includes a wheel 1 and at least one first wavelength converting unit 2. The wheel 1 has at least one first-color light generating region 101a and at least one first-color light correcting region 101b, wherein the first-color light generating region 101a and the first-color light correcting region 101b are alternatively distributed in a first-color light generating area 101 along a rotation direction D of the wheel 1. The light guide module 3 has a first light guide unit 301, a second light guide unit 302, a third light guide unit 303, and a fourth light guide unit 304, configured to guide the light L.

As shown in FIG. 1, in the present embodiment, the wheel 1 has a plurality of color light generating areas—a first-color light generating area 101, a second-color light generating area 102, and a third-color light generating area 103, respectively. Each of the color light generating areas (101,102, and 103) are respectively configured to generate different color lights in colors, wherein both the first-color light generating region 101a and the first-color light correcting region 101b are located on the first-color light generating area 101, configured to generate a first composite light L1. The second-color light generating area 102 and the third-color light generating area 103 are configured to generate color lights which are different from the first composite light L1 in colors. For example, the whole second-color light generating area 102 may be coated by a second wavelength converting material (not illustrated in FIGs), configured to convert the wavelength of the light L and generate the second-color light which is different from the emergent first composite light L1 in color (not illustrated in FIGs). The whole third-color light generating area 103, for example, may be coated by a light-scattering material so as to reflect the light L, or the third-color light generating area 103 may be made of a light transmissive material so as to enable the emergent third-color light (not illustrated in FIGs) to be the same color as the incident light L, and the present disclosure is not limited thereto. In addition, in the present embodiment, the wheel 1 has three color light generating areas (101,102, and 103); however, the present disclosure is not limited thereto. For example, in another embodiment, the wheel 1 may merely have the first-color light generating area 101, configured to generate the first composite light L1; or in another embodiment, the wheel 1 may have more than three color light generating areas, respectively configured to generate lights that are different in color to each other, and each of the color light generating areas are configured to generate different lights in color at different times so as to correspond to the time periods of the different colors projected by the projector.

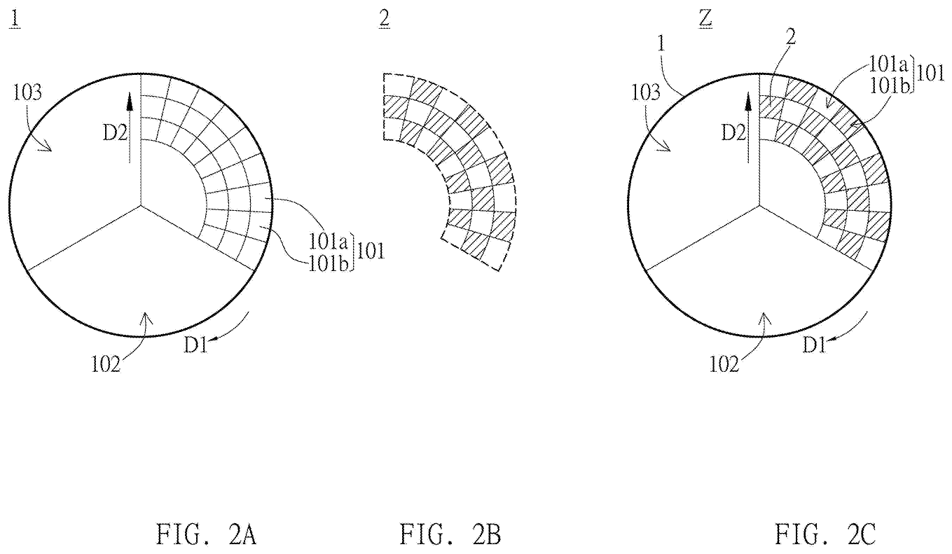

Please refer to FIG. 1 and FIG. 2A to FIG. 2C. FIG. 2A illustrates a diagram of the wheel 1 of the present embodiment where the first wavelength converting unit 2 are not disposed, wherein the first-color light generating region 101a and the first-color light correcting region 101b are alternatively disposed along the rotation direction D1. FIG. 2B illustrates the first wavelength converting unit 2 of the present embodiment, arranged as the same way as the first-color light correcting region 101b. FIG. 2C illustrates the first wavelength converting unit 2 of the present embodiment in FIG. 2B disposed on the wheel 1 in FIG. 2A and the location corresponds to the first-color correcting region 101b. In the present embodiment, the projector U is configured to project the first composite light L1 containing the first color using the first-color light generating area 101 during a first time period T. The light L in FIG. 1 is incident on one of the first-color light generating regions 101a during a first period T1 of the first time period T, so that an uncorrected first-color light L11 is generated. Each of the first wavelength converting units 2 are respectively disposed on each of the first-color light correcting regions 101b, so that the first wavelength converting unit 2 is excited and a corrected color light L12 is generated when the light L is incident on the first-color light correcting region 101b adjacent to the first-color light generating region 101a during a second period T2 of the first time period T following the first period T1. Through the aforementioned method, since the first-color light correcting region 101b and the first-color light generating region 101a are alternatively distributed along the rotation direction D1, light generated after the light L is overlapped during each incident periods may have a higher uniformity.

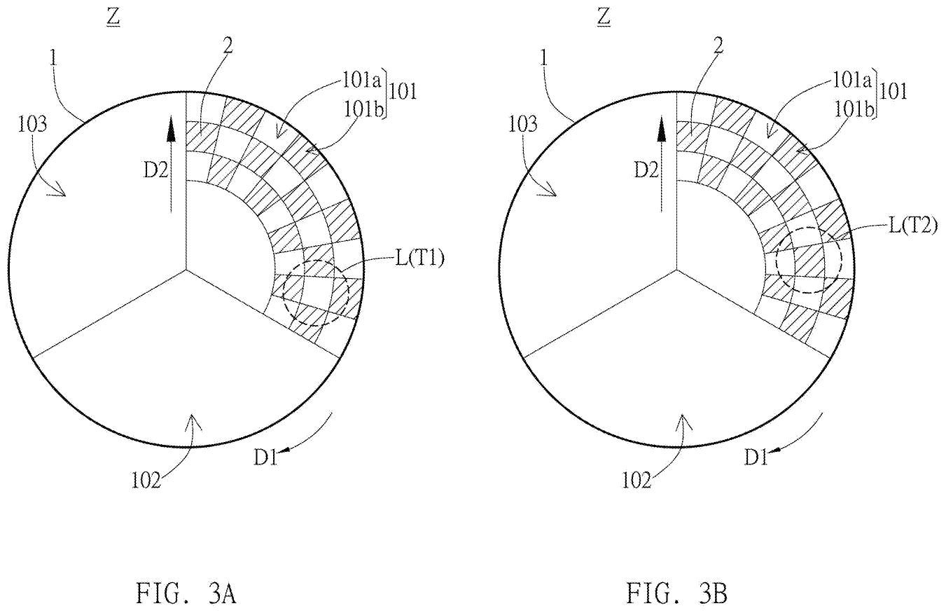

In the embodiment of FIG. 1, during the first period T1, the light L is only incident on the first-color light generating region 101a, and during the second period T2, the light is only incident on the first-color light correcting region 101b; however, the present disclosure is not limited thereto. People skilled in the art may suitably choose a location where the light L is incident on the first-color light generating area 101, or they may adjust the sizes of the first-color light generating region 101a and the first-color light correcting region 101b according to the requested size of the output light. For example, as shown in FIG. 2C, the first-color light generating region 101a and the first-color light correcting region 101b in the present embodiment are not only alternatively distributed along the rotation direction D of the wheel 1, but also alternatively distributed along a radial direction D2 of the wheel 1. Thus, since the first-color light generating region 101a and the first-color light correcting region 101b are alternatively distributed along both the rotation direction D1 and the radial direction D2, when the wheel 1 rotates to enable the light L to go through the first-color light generating area 101 in the variant embodiment illustrated in FIG. 3A and FIG. 3B, during the first period T1, the light L not only may be incident on the first-color light generating region 101a, its range may also include the first-color light correcting region 101b around the first-color light generating region 101a, during the second period T2, the light L not only may be incident on the first-color light correcting region 101b, its range may also include the first-color light generating region 101a. Therefore, the present variant embodiment not only may achieve the effect of the embodiment in FIG. 1, that is, the effect of a higher uniformity of the light generated after the light L is overlapped during each of the incident period, but also may uniformly combine the uncorrected first-color light L11 with the corrected color light L12 outputted by each unit of time so that the uniformity of the first composite light L1 may be enhanced.

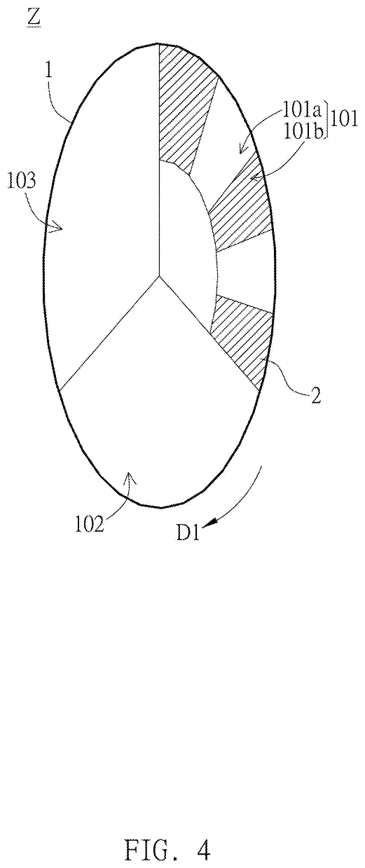

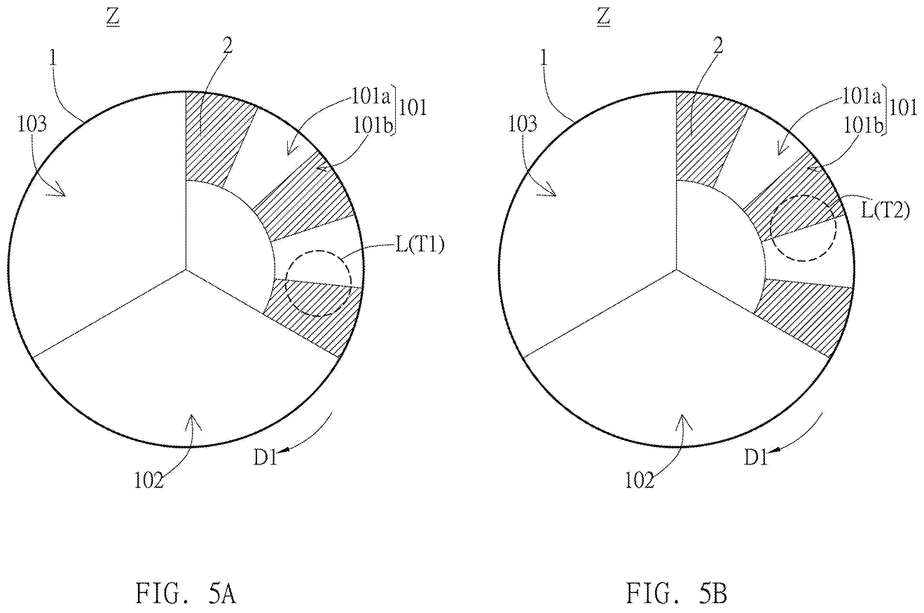

In addition, in the embodiment of FIG. 1, the first-color light generating region 101a and the first-color light correcting region 101b are alternatively distributed along both the rotation direction D1 and the radial direction D2; however, the present disclosure is not limited thereto. In another embodiment, the first-color light generating region 101a and one of the first-color light correcting regions 101b, as shown in FIG. 4, may be alternatively arranged only along the rotation direction D1. Please refer to FIG. 5, illustrating an active state embodiment of the wavelength conversion module Z of FIG. 4. As shown in FIG. 5, the light L is incident on a portion of the first-color light generating region 101a and a portion of the first-color light correcting region 101b during the first period T1 so that the mixed light of the uncorrected first-color light L11 and the corrected color light L12 is generated. The light L is similarly incident on a portion of the first-color light generating region 101a and a portion of the first-color light correcting region 101b during the second period T2. Thus, the first-color light generating region 101a and the first-color light correcting region 101b alternatively arranged in the first-color light generating area 101 along the rotation direction D1 may uniformly combine the uncorrected first-color light L11 with the corrected color light L12 at each unit of time so that the uniformity of the first composite light L1 may be enhanced.

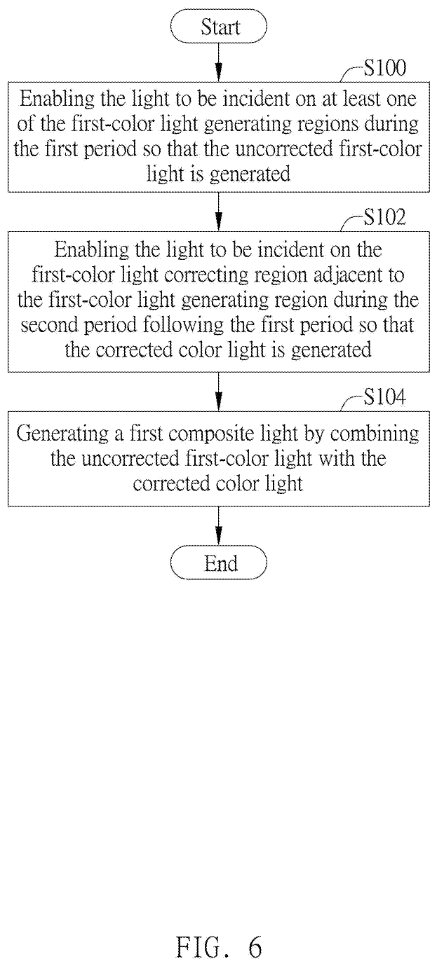

Please refer to FIG. 1 and FIG. 6. The present embodiment further provides a method for mixing light of the projector U, which includes at least the following steps. A step S100: enabling the light L to be incident on at least one of the first-color light generating regions 101a during the first period T1 so that the uncorrected first-color light L11 is generated; a step S102: enabling the light L to be incident on the first-color light correcting region 101b adjacent to the first-color light generating region 101a during the second period T2 following the first period T1 so that the corrected color light L12 is generated: and a step S104: generating a first composite light L1 after combining the uncorrected first-color light L11 with the corrected color light L12.

Specifically, in the present embodiment, the light L is a blue laser, and the first-color light generating region 101a is a transparent material. In the step S100, the light L generated by the light source S is reflected by the first light guide unit 301 of the light guide module 3 to the wheel 1 so that the light L may be incident on the first-color light generating region 101a during the first period T1. Since the first-color light generating region 101a of the present embodiment enables light to go through, the light L goes through the wheel 1 so as to generate the uncorrected first-color light L11 having the same color as the light L. Then, the uncorrected first-color light L11 is sequentially reflected by the second light guide unit 302, the third light guide unit 303 and the fourth light guide unit 304, and is finally guided to go back to the first light guide unit 301.

Since the first-color light generating region 101a and the first-color light correcting region 101b are alternatively distributed along the rotation direction D of the wheel 11, the light L is incident on the first-color light generating region 101a and the first-color light correcting region 101b alternatively in time sequence. Then, during the step S102 after the first period T1, the light L is incident on the first-color light correcting region 101b during the second period T2. The first wavelength converting unit 2 is excited by the light L to generate the corrected color light L12. The first wavelength converting unit 2 may be a fluorescent powder or a quantum dot material, but the present disclosure is not limited thereto. In the present embodiment, the corrected color light L12 generated after the first wavelength converting unit 2 is excited by the light L is a green light, as such, in the step S104, the corrected color light L12 of green and the uncorrected first-color light L11 of blue are combined to generate the corrected first composite light L1 of blue. It should be noted that, the color of the corrected color light L12 is not limited thereto. In another embodiment, the color of the corrected color light L12 may be determined based on the correction request, and one may select the suitable first wavelength converting unit 2 in the first-color correcting region 101b according to the predetermined color of the corrected color light L12, so that the color light emitted after the first wavelength converting unit 2 being excited by the light L may generate the predetermined color of the corrected color light L12.

In the step S104, the corrected color light L12 generated by the first wavelength converting unit 2 goes through the first light guide unit 301, and the uncorrected first-color light L11 is secondarily reflected by the first light guide unit 301 after being reflected at the second light guide unit 302, the third light guide unit 303 and the fourth light guide unit 304, and is combined with the corrected color light L12 which has gone through the first light guide unit 301, so as to generate the first composite light L1.

Furthermore, a chromaticity coordinates (x₁, y₁) of the first composite light L1 of the present embodiment in the chromaticity diagram (CIE1931) satisfies:

0.14≤x₁≤0.16

0.05≥y₁≤0.07

The first composite light L1 within the aforementioned chromaticity range is close to blue in tricolor. And the chromaticity coordinates(x₂, y₂) of the light L used by the projector U of the present embodiment in the chromaticity diagram (CIE1931) satisfies:

0.14≤x₂≤0.16

0.01≤y₂≤0.03

In chromaticity diagram (CIE1931), the chromaticity range of the light L is located between blue and violet, and has higher energy than laser beam of original blue; therefore the efficiency to excite the fluorescent powder is high. In the present embodiment, the light L of high exciting efficiency is used as the light source S of a projector Z, and the uncorrected first-color light L11 of partially violet is corrected to be original blue by combining the corrected color light L12 of green with the uncorrected first-color light L11. Thus, the embodiment of the present disclosure may achieve both high exciting efficiency and the color accuracy of the projector Z at the same time.

It should be noted that, the arrangement spacing between the first-color light generating region 101a and the first-color light correcting region 101b and the forms of them in FIG. 1 and FIG. 2A to FIG. 2C are merely used for description, and the present disclosure is not limited thereto. People skilled in the art may modulate the quantity ratio between the first-color light generating region 101a and the first-color correcting region 101b and may modulate the arrangement between the first-color light generating region 101a and the first-color correcting region 101b according to the requested brightness proportion between the uncorrected first-color light L11 and the corrected color light L12. For example, if about 20% of the corrected color light L12 and about 80% of the uncorrected first-color light L11 are required to be combined in a variant embodiment, the area of the first-color light generating region 101a may be four times as the first-color light correcting region 101b in the first-color light generating area 101, and the arrangement of the first-color light generating region 101a and the first-color light correcting region 101b may be as follows: the first-color light generating region 101a and the first-color light correcting region 101b are alternatively arranged with a 4 to 1 ratio of unit areas along the rotation direction D of the wheel 11 and the radial direction D2. Possibly, in another variant embodiment, the first-color light correcting region 101b may be distributed between the first-color light generating regions 101a randomly.

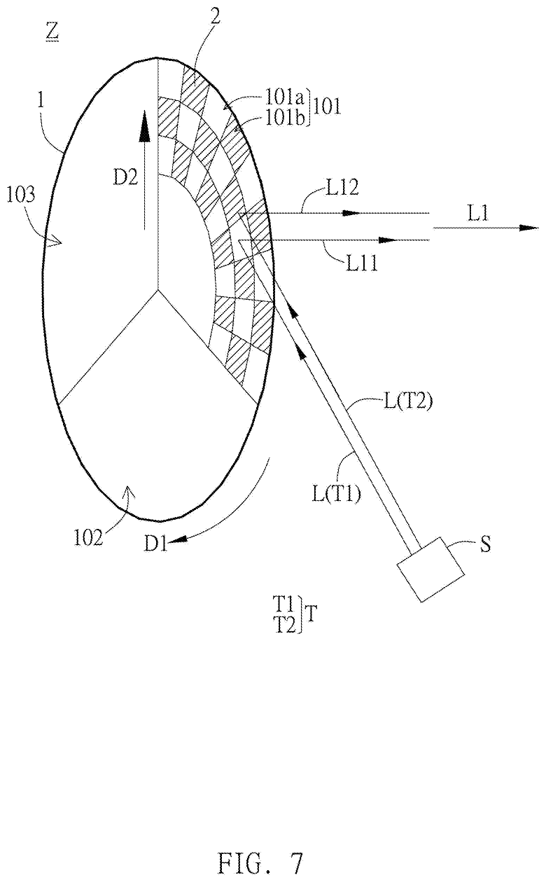

In addition, the transparent material is used as the first-color light generating region 101a in the present embodiment; however the present disclosure is not limited thereto. For example, in the variant embodiment illustrated in FIG. 7, the first-color light generating region 101a is made of a reflective material, configured to reflect the light L to generate the uncorrected first-color light L11. The reflected uncorrected first-color light L11 is directly combined with the corrected color light L12 generated by exciting the first wavelength converting unit 2 so as to generate the first composite light L1. It should be noted that, the structure of the light source of the projector Z of the first embodiment of the present disclosure is configured to guide and mix the light L by using the light guide module 3; however such is merely one of the embodiments of the present disclosure, and the present disclosure is not limited thereto. For example, in the embodiment of FIG. 7, the wavelength conversion module Z may generate the first composite light L1 without the light guide module 3.

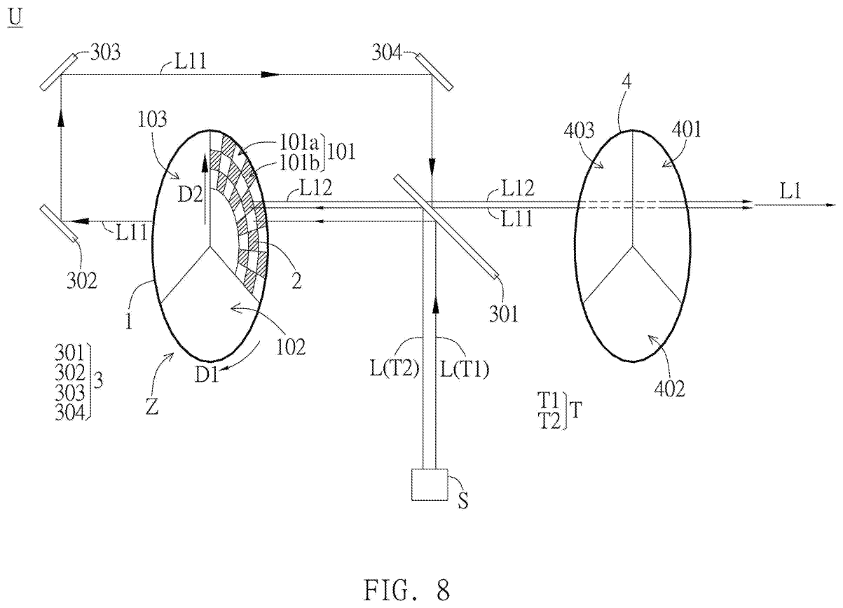

Please refer to FIG. 8. In another variant embodiment, the projector U may further include a filter color wheel 4. The filter color wheel 4 at least has a first-color light filtering area 401 corresponding to the first-color light generating region 101a and the first-color light correcting region 101b so as to enable the uncorrected first-color light L11 and the corrected color light L12 to go through the first-color light filtering area 401. More specially, the filter color wheel 4 is configured to filter lights of non-target wave band so as to enhance the color purity of the light which has gone through the filter color wheel 4. For example, the first-color light filtering area 401 is configured to filter the light of the wave band not belonging to the first composite light L1 from the uncorrected first-color light L11 and the corrected color light L12 so that the first composite light L1 with high color purity may be generated after combining the corrected light L12 of the first-color light filtering area 401 with the uncorrected first-color light L11.

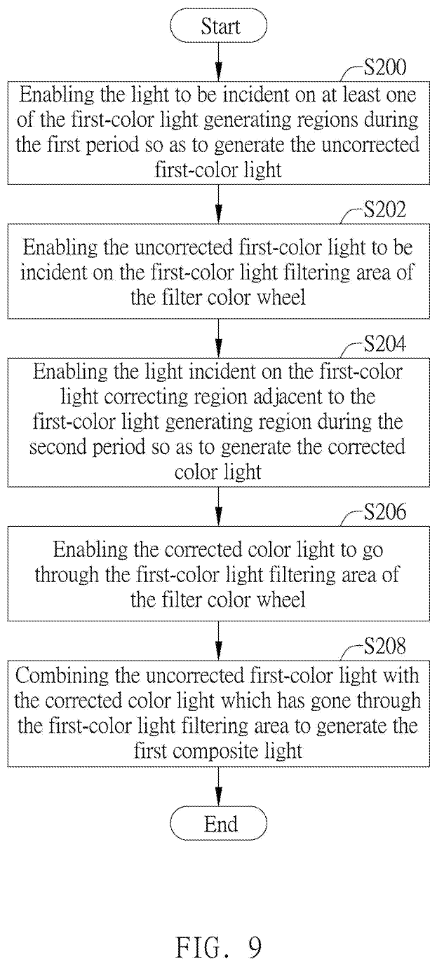

Please refer to FIG. 8 and FIG. 9. The present disclosure further provides a method for mixing light of the projector U illustrated in FIG. 8, which at least includes the following steps. A step S200: enabling the light L to be incident on at least one of the first-color light generating regions 101a during the first period T1 so as to generate the uncorrected first-color light L11; a step S202: enabling the uncorrected first-color light L11 to be incident on the first-color light filtering area 401 of the filter color wheel 4; a step S204: enabling the light incident on the first-color light correcting region 101b adjacent to the first-color light generating region 101a during the second period T2 so as to generate the corrected color light; a step S206: enabling the corrected color light L12 to go through the first-color light filtering area 401 of the filter color wheel 4; and a step S208: combining the uncorrected first-color light L11 with the corrected color light L12 which has gone through the first-color light filtering area 401 to generate the first composite light L1.

In the embodiment of FIG. 8, the filter color wheel 4 has three light filtering areas corresponding to the wheel 1, and they are: the first-color light filtering area 401 corresponding to the first-color light generating area 101, configured to filter the uncorrected first-color light L11 and the corrected color light L12 emitted by the first-color light generating area 101; the second-color light filtering area 402 corresponding to the second-color light generating area 102, configured to filter the light emitted by the second-color light generating area 102; and the third-color light filtering area 403 corresponding to the third-color light generating area 103, configured to filter the light emitted by the third-color light generating area 103. However, the present disclosure is not limited thereto. In another embodiment, the structure of the filter color wheel 4 may be modified based on the request for light filtering.

In summary, in the first embodiment of the present disclosure, the first wavelength converting unit 2 and the first-color light generating region 101a are alternatively disposed along the rotation direction D1 so that the incident light L emitted by the light source S is incident on the first-color light generating region 101a and the first-color light correcting region 101b alternatively in time sequence. Thus, the uncorrected first-color light L11 and the corrected color light L12 may be alternatively generated after the time sequence so that the first composite light L1 generated after mixing the uncorrected first-color light L11 and the corrected color light L12 has a higher chromaticity consistency within each unit of time.

### The Second Embodiment

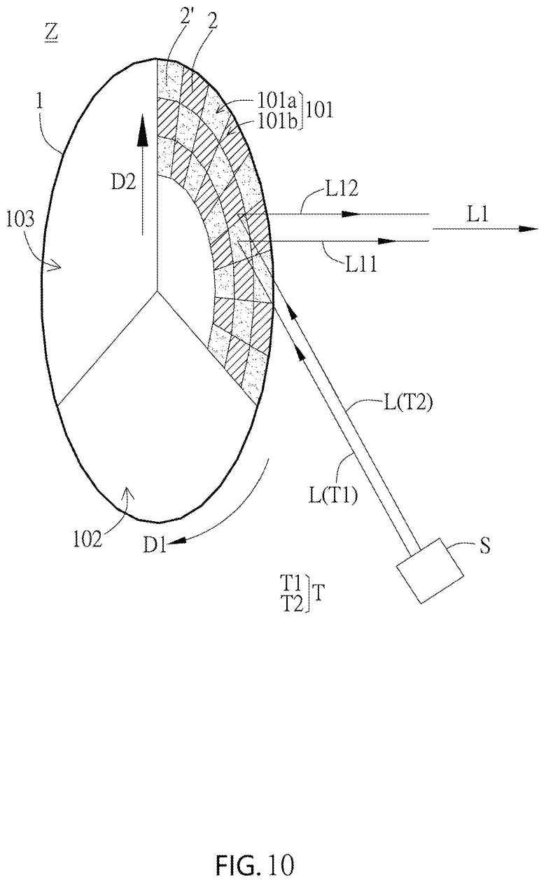

Please refer to FIG. 10, illustrating the wavelength conversion module Z provided by the second embodiment of the present disclosure. The difference between the wavelength conversion module Z of the second embodiment of the present disclosure and the wavelength conversion module Z of the first embodiment is that: in the first embodiment, the color of the first-color light generated during the first time period T is blue, and the color of the incident light L is also blue, therefore the fluorescence powder is not required to be disposed on the first-color light generating area 101 to convert the color of the light L; in the present embodiment, the wheel 1 further includes a third wavelength converting unit 2′, respectively disposed on each of the first-color light generating region 101a, and configured to convert the wavelength of the light L to generate the uncorrected first-color light L11 different from the light L in color.

For example, in the embodiment of FIG. 10, the light L emitted by the light source S is a blue laser. The third wavelength converting unit 2′ is excited by the light L to generate the uncorrected first-color light L11, for example, which may be a green light. And the corrected color light L12 generated after the first wavelength converting unit 2 is excited by the light L is configured to correct, for example, a yellow light or a blue-green light to be green light so that the first composite light L1 of green generated by combining the uncorrected first-color light L11 with the corrected color light L12 may achieve the expected chromaticity. The aforementioned contents are merely used as an example, and the present disclosure is not limited thereto. In another embodiment, the uncorrected first-color light L11 may be a light except blue light and green light, and the first wavelength converting unit 2 is configured to make the corrected color light L12 generated by excitation correct the color of the uncorrected first-color light L11 so that the first composite light L1 generated by combining the uncorrected first-color light L11 with the corrected color light L12 may achieve the expected chromaticity.

In summary, through the technical features of “having at least one first-color light generating region 101a and at least one first-color light correcting region 101b alternatively distributed along the rotation direction D of the wheel 11” and “having at least one first wavelength converting units 2 respectively disposed on each of the first-color light correcting regions 101b to convert the wavelength of the light L,” the wavelength conversion module Z, the projector U and the method for mixing light of the projector provided by the embodiments of the present disclosure enable the light L to be incident on at least one of the first-color light generating regions 101a so as to generate the uncorrected first-color light L11 during the first period T1 of the first time period T, and enable the light L to be incident on the first-color light correcting region 101b adjacent to the first-color light generating region 101a so as to generate the corrected color light L12 during the second period T2 of the first time period T following the first period T1.

The aforementioned descriptions represent merely the better modes of present disclosure, without any intention to limit the scope the present disclosure, Various equivalent changes, alternations, modifications based on the specification and FIGs of the present disclosure, are all embraced by the scope of the present disclosure.

What is claimed is:

1. A wavelength conversion module disposed on a transmission path of a light emitted by a projector, the wavelength conversion module comprising:
a wheel comprising a first-color light generating area, the first-color light generating area comprising at least one first-color light generating region and at least one first-color light correcting region, the at least one first-color light generating region and the at least one first-color light correcting region alternatively distributed in the first-color light generating area along a rotation direction of the wheel; and
at least one first wavelength converting unit disposed on each of the at least one first-color light correcting region and configured to convert the wavelength of the light,
wherein the light is incident on one of the at least one first-color light generating region during a first period of a first time period where the projector projects light of a first color so that an uncorrected first-color light is generated, and incident on the at least one first-color light correcting region adjacent to the first-color light generating region during a second period of the first time period consecutive to the first period so that a corrected color light is generated,
wherein the uncorrected first-color light is combined with the corrected color light to generate a first composite light.

2. The wavelength conversion module according to claim 1, wherein the wheel comprises a second-color light generating area, the second-color light generating area is adjacent to the first-color light generating area in the rotation direction of the wheel, and the wavelength conversion module further comprises a second wavelength converting unit disposed on the second-color light generating area and configured to convert the light to a second-color light different from the first composite light in color, wherein the second-color light is generated by the second-color light generating area during a second time period where the projector projects light of a second color.

3. The wavelength conversion module according to claim 1, wherein the wheel comprises a third-color light generating area, the third-color light generating area is adjacent to the first-color light generating area in the rotation direction of the wheel, and the third-color light generating area is a transparent material or a reflective material.

4. The wavelength conversion module according to claim 1, wherein the light is the uncorrected first-color light, and the first-color light generating region is a transparent material or a reflective material.

5. The wavelength conversion module according to claim 1, wherein chromaticity coordinates(x₁, y₁) of the first composite light in a chromaticity diagram (CIE1931) satisfies:
0.14≤x₁≤0.16
0.05≤y₁>0.07.

6. The wavelength conversion module according to claim 5, wherein chromaticity coordinates(x₂, y₂) of the light in the chromaticity diagram satisfies:
0.14≤x₂≤0.16
0.01≤y₂≤0.03

7. The wavelength conversion module according to claim 1, further comprising:
at least one third wavelength conversion unit respectively disposed on each of the at least one first-color light generating region and configured to convert the light to the uncorrected first-color light.

8. The wavelength conversion module according to claim 1, wherein the at least one first-color light generating region and the at least one first-color light correction region are alternatively distributed along a radial direction of the wheel.

9. A projector, comprising:
the wavelength conversion module according to claim 1; and
a light source configured to emit the light.

10. The projector according to claim 9, further comprising:
a filter color wheel having a first-color light filtering area corresponding to the at least one first-color light generating region and the at least one first-color light correcting region,
wherein the uncorrected first-color light and the corrected color light going through the first-color light filtering area are combined to generate the first composite light.

11. A method for mixing light of the projector according to claim 9, comprising:
enabling the light to be incident on one of the at least one first-color light generating region during the first period so that the uncorrected first-color light is generated;
enabling the light to be incident on the at least one first-color light correcting region adjacent to the first-color light generating region during the second period so that the corrected color light is generated;
combining the uncorrected first-color light with the corrected color light to generate the first composite light.
